(19) United States
(12) Patent Application Publication
(10) Pub. No.: US 2002/0061692 A1
(43) Pub. Date: May 23, 2002

(54) FLAT COMPOSITE FABRIC WITH MEMORY METAL AND ITS APPLICATIONS

(76) Inventors: HELGE G. STECKMANN, GRAVENWIESBACH (DE); VIKTOR PRIEB, BERLIN (DE)

Correspondence Address: BRIAN M BERLINER, GRAHAM & JAMES, 801 S FIGUEROA ST 14TH FLOOR, LOS ANGELES, CA, 900175554

(21) Appl. No.: 08/732,927

(22) Filed: Oct. 17, 1996

(51) Int. Cl. D03D 15/04; B32B 3/06; D03D 15/00; B32B 15/14

(52) U.S. Cl. 442/229; 442/7; 442/8; 442/31; 442/182; 442/228; 428/102; 601/6; 601/7

(57) ABSTRACT

A flat composite fabric is provided by incorporating wire made of memory metal, or made of an alloy possessing shape memory properties into a flat fabric. By means of appropriate heating and cooling, e. g. electric heating, the composite fabric is contracted and released thereby providing a massaging effect.

The invention relates to a flat composite fabric with memory metal, and to its applications in medicine, aero-nautics and space technology.

In the field of medicine, support or compression dressings are used to treat edemas or swellings of the limbs. For these purposes, rubber-like materials are used which exert a constant force on the body region lying beneath them. A disadvantage of these conventional support or compression dressings and sleeves is that the contact force which is exerted cannot be regulated. They have to be applied in an already taut state onto the body area in question, and this proves to be more or less difficult depending on the desired pressure upon the body after application.

In the treatment of post-operative edemas, in conjunction with fractures for which fixators are necessary, the use of conventional elastic support or compression dressings is made considerably difficult or in some cases impossible.

In the field of sports medicine and orthopedics, use is also made of so-called joint ortheses which have rigid components which are connected to one another via hinge connections and so permit bending of the knee, etc. A disadvantage of these known knee ortheses is that they are very expensive, since they have to be individually adapted or manufactured. In addition to this, the rigid elements mean that the wearing comfort suffers.

For treatment of swellings and edemas of various types, it is known to use appliances with intermittent compression. Such devices, as are described, for example, in offprint 2/90 of Feb. 15, 1990, “Der niedergelassene Arzt: Die Therapie des Lymphödems” [The general practitioner: The treatment of lymphatic edema], comprise sleeves with individual air chambers which are acted on by compressed air, either together or independently of one another. An improved device which can also build up pressure gradients is known from the company brochure Vasomed Aktuell, 7th year, number 2/95, with the title: “Neuester Stand der apparativen intermittierenden Kompression: Das 3-Phasen-Gradient-System” [Latest developments in intermittent compression apparatuses: The 3-phase gradient system]. Such devices are also offered for sale by the company Bösl Medizintechnik GmbH, 52068 Aachen, under the designation “lympha-mat GRADIENT” (twelve-chamber system) and “vasoflow GRADIENT”. These known massage devices for intermittent compression are comparatively expensive, because an air compressor is required. In addition, because of the changing volume of the compressed air chambers, these devices cannot be used in cases of fractures which are secured by a fixator.

In the field of aeronautics and space technology too, use is made of pressure suits for pilots, these suits having air chambers which are acted upon by compressed air as and when required, in order to prevent the removal of blood from the head region to the extremities. On account of the volume of the air chambers, these pressure suits are comparatively cumbersome and their operation is technically complex, since they are likewise operated using compressed air.

Trendletter 05/94 - Innovations discloses a mattress which prevents bedsores in bedridden patients. In this electric mattress developed by the Japanese company Nippon Tungsten Co. (20-31, Shimizu 2-chome, Minami-ku, Fukuoka 815), and similar to an electric blanket, the surface of the mattress rises and falls in an undulating manner at regular intervals. This is achieved by means of thin, woven-in wires made of a shape-memory alloy which changes shape on reaching a defined temperature. The time intervals are regulated using a timer.

From U.S. Pat. No. 5,261,871 an elastic support brace having a plurality of pockets capable of receiving flexible wire members or bars made of alloy comprising memory properties. By filling an appropriate number of pockets the brace may be customized for a patient having a particular injury.

From DE-A-33 22 598 a composite material is known comprising a plastic matrix surrounding bars of alloy having shape memory properties.

U.S. Pat. No. 4,665,906 is directed to medical devices using stress-induced martensite alloy elements. The use of stress-induced martensite decreases the temperature sensitivity of the medical devices thereby making them easier to install and/or remove.

From German Utility Model No. 92 18 774.9 an orthopedic knee brace is known comprising an electric heating system to contrallably heat up an injured knee.

It is an object of the present invention to provide a composite fabric with memory metal alloy which is easy to manufacture and can be used in a wide variety of applications.

It is also an object of the present invention to specify a compression or support dressing, a massage device, or a device for intermittent compression, and a pressure suit for pilots, all of which comprise a composite fabric of this type.

This object is achieved by the features of claims 1, 16, 19 and 22.

By means of the filaments or wires made of memory metal, or made of an alloy possessing shape memory properties, being permanently incorporated into a flat or two-dimensional fabric, a flat or two-dimensional composite fabric is obtained which can be used in a wide variety of applications.

According to further aspect of the invention, the wires made of memory metal are incorporated between two flat layers of fabric in a sandwich configuration. This can be done by means of ultrasonic welding, for example. According to a further aspect the invention, the memory metal wires are stitched onto a flat fabric. In both cases, the composite fabric according to the invention is manufactured in a simple way using a conventional fabric and commercially available wires made of memory metal.

When using the composite fabric according to the invention in a compression or support dressing as claimed in claim 16, the metal alloy for the memory wires is chosen such that the temperature Aₛ, at which the linear contraction of the filaments begins during a temperature increase, is greater than the average body temperature of the part of the body onto which the compression or support dressing is applied. The result of this is that the compression or support dressing can be applied in the untensioned state. Once the compression or support dressing according to the invention has been applied in the desired way, it is then possible, by increasing the temperature to above the temperature Aₛ, to selectively initiate the contraction and, with it, the pressure increase.

Using the two-way memory effect is advantageous, because in this way a massage effect involving repeated tensioning and untensioning can be achieved (claim 4). This is advantageously assisted by means of an elastic fabric (claim 5).

By using wires with a round cross section, the risk of injury is minimized, and round wires are easy to manufacture (claim 6).

By means of the advantageous embodiment of the invention as claimed in claims 7 and 8, the maximum obtainable contraction is increased, and with it the maximum pressure that can be exerted.

By using different cross sections of wire (claim 9), the mechanical properties of the composite fabric can be selectively influenced and varied in different surface sections.

The required increase in temperature can be brought about in a simple way by means of electric current (claim 10). Temperature control can also be achieved by this simple means.

In addition, or alternatively, the heating or increase in temperature can be obtained inductively. To do this, current surges are induced in closed wire coils made of memory metal (claim 11). An electrically insulating fabric (claim 12) increases safety when heating by means of current.

By providing the composite fabric in the form of a continuous dressing or bandage which is wound up to form a roll of dressing, it is possible for dressing material comprising the composite fabric according to the invention to be used in the same way as conventional rolls of dressing (claim 13). This is also true of the design in the form of a sleeve (claim 14).

By means of the materials and compounds specified in claim 15, the critical temperatures of the memory metals can be shifted or adjusted to the desired temperature ranges.

By means of the advantageous embodiment of the invention as claimed in (claims 16, 17 and 18, the compression and support dressing according to the invention can be applied as a conventional dressing, and then, in the applied state, the contraction and, with it, the increase in pressure can be brought about in a selective manner. By appropriate choice of temperature (claim 17), a secure hold or a permanent contraction is guaranteed.

When using the composite fabric according to the invention to make available a massage device or a device for generating intermittent compression as claimed in claim 19, the temperature hysteresis of the memory metal alloy is chosen such that both the temperature Aₛ, at which the linear contraction begins during the increase in temperature, and the temperature M_{f}, at which the filaments again begin to assume their original length during the decrease in temperature, are higher than the average temperature of the body to be massaged. In this way it is possible for contraction to take place, for example by periodically heating the memory metal wires by means of short current impulses, and this contraction is then made reversible again, as a result of cooling to the ambient temperature or body temperature, by means of switching off the flow of current.

Further details, features and advantages of the invention will be evident from the following description of preferred embodiments, given with reference to the drawings, in which:

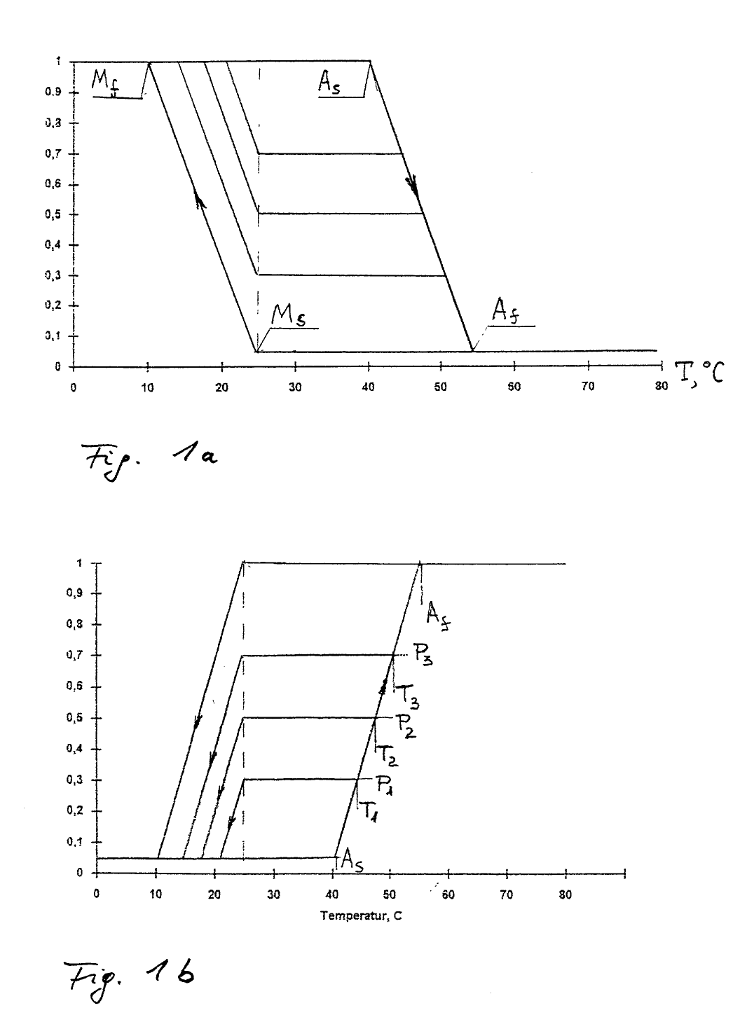

FIGS. 1a and 1b are hysteresis diagrams of memory metal alloys, as used in the present invention,

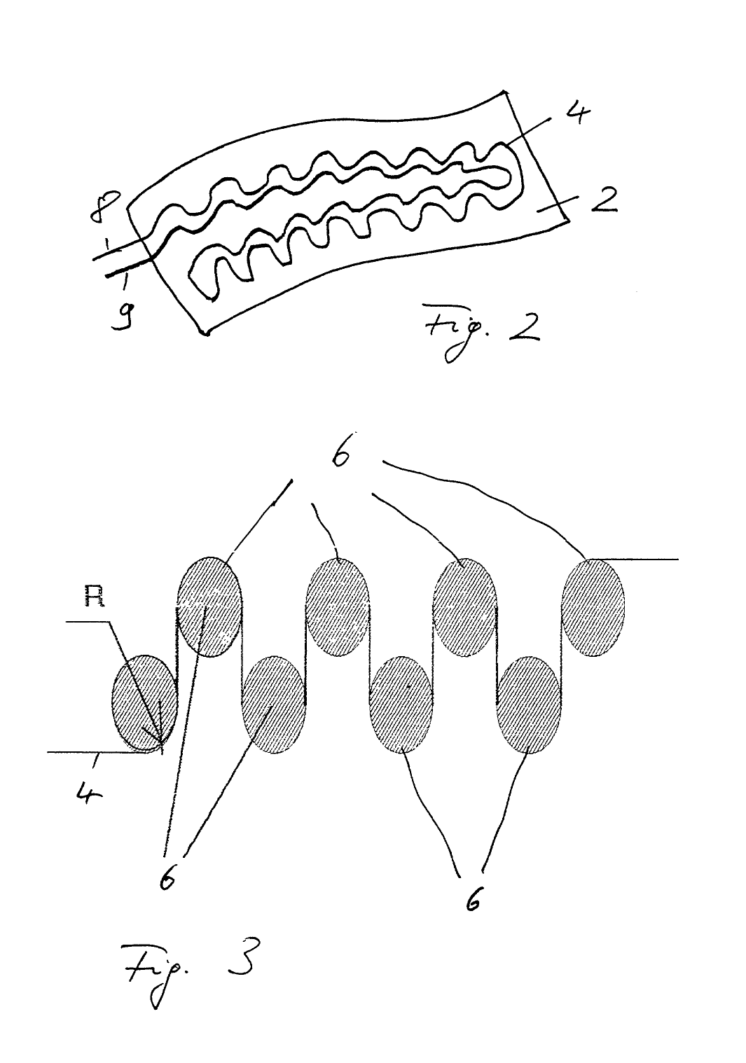

FIG. 2 is a diagrammatic representation of a two-dimensional fabric with memory metal wires incorporated therein,

FIG. 3 is a diagrammatic representation of the manufacture of memory metal wires in a meandering configuration,

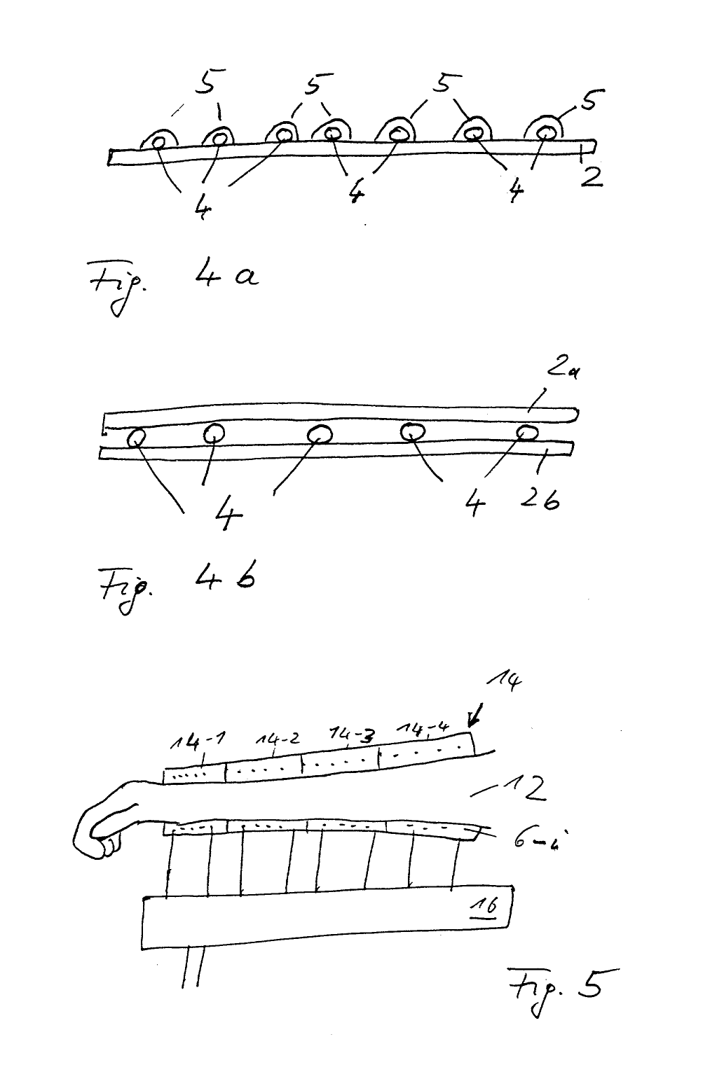

FIGS. 4a and 4b show examples of incorporation of the memory metal wires into the two-dimensional fabric, and

FIG. 5 is a diagrammatic representation of a massage device according to the present invention.

A distinction is drawn between the one-way memory effect and the two-way memory effect. In the case of the one-way memory effect, the memory metal is mechanically deformed, and the deformation is reversed again by heating the deformed piece of metal to above the temperature Aₛ. Renewed cooling of the memory metal, however, does not lead to any further change in shape, and we therefore talk of a one-way memory effect. In the case of the two-way memory effect, a piece of memory metal is first deformed to such a great extent that some of the deformation is irreversible. On subsequent heating to above the temperature Aₛ, the deformation is only partially cancelled, and subsequent cooling then leads to a reverse deformation which does not, however, extend completely to the original deformation. By heating and cooling it is then possible to alternate reversibly between the two deformation states (two-way effect). Further details of this are known, for example, from the offprint of the “Zeitschrift für wirtschaftliche Fertigung”, 81st year 1986, volume 12, page 203, by Dr P. Tautzenberger and Prof. Dr D. Stöckel: “Anwendung von Formgedächtnis-legierungen in der Technik” [Use of shape memory alloys in technology].

The maximum reversible deformation which can be achieved under external load is ca. 8% in the case of the known memory metal alloys (one-way effect). The repeated exposure of the loaded wires to above the transition temperature range exercises these wires in the two-way effect, the reversible deformation taking place spontaneously, and without external loading, to the extent of up to 3% during the exposure above the transition temperature range.

FIGS. 1a and 1b show diagrammatically an ideal hysteresis curve (two-way effect) of memory metal alloys, the X axis in FIGS. 1a and 1b showing the temperature, and the Y axis in FIG. 1a showing the length or extension of a memory metal wire, and the Y axis in FIG. 1b showing the pressure obtained with a composite fabric according to the present invention, these being plotted in relative units. Here, Mₛ is the temperature at which the martensitic transformation or deformation begins during the increase in temperature, M_{f} is the temperature at which the martensitic transformation ends or deformation is at its maximum, Aₛ is the temperature at which the martensitic retransformation begins during the decrease in temperature, and A_{f} is the temperature at which the retransformation ends.

In FIG. 1a, taking as a starting point a wire with maximum length (y=1), the temperature is increased to a temperature Aₛ, at which the contraction of the wire begins. The contraction continues (y becomes smaller) until a temperature A_{f} is reached. On further increasing the temperature, no further contraction takes place. If the memory wire is now cooled, the retransformation begins at a temperature Mₛ, which is lower than the temperature Aₛ, and the wire begins to extend again (y becomes longer again). This extension continues until the original state (y=1) is again reached, ideally at a temperature M_{f}.

FIG. 1b shows an analogous representation, the only difference being that the pressure which can be generated is plotted in relative units on the Y axis. As can be seen from FIGS. 1a and 1b, the degree of the linear contraction and, with it, of the applied pressure can be adjusted by heating to a defined temperature which lies below the maximum temperature possible in each particular case. That is to say, the inner hysteresis loops are passed through.

FIG. 2 shows a first embodiment of the invention in the form of a two-dimensional composite fabric, which has a two-dimensional strip or sheet of fabric 2 and a memory wire 4 incorporated therein. The memory wire 4 is designed in a meandering configuration, by which means the linear change in the wire, and in the fabric 2 in which the memory wire 4 is incorporated, is multiplied.

The deformation of the memory wire 4 into a meandering flat spring is preferably effected by means of a bending tool, as is represented diagrammatically in FIG. 3. As can be seen from FIG. 3, the memory wire 4 is bent in a meandering configuration about rounded bending rods 6 which are arranged offset in relation to one another. Here, the radius R designates the radius of curvature of the outer surface of the bending rods 6, and r designates the radius of the memory wires 4. In a particularly advantageous embodiment of the invention, the following relationship applies:

r/R×100%<8%

The memory wire 4 in the embodiment according to FIG. 2 is designed as a continuous wire and finishes in electrical connections 8 and 9. An electric current supply device (not detailed) can be joined up to the electrical connections 8 and 9, by means of which device the memory wire 4 is heated by short current impulses to a temperature T above the temperature Aₛ, which leads to a contraction of the wire 4 and consequently of the fabric 2.

If, for example, the composite fabric from FIG. 2 is used as a support dressing round a knee, the strip or sheet of composite fabric is first applied to the knee in the manner of a conventional elastic dressing, and the memory wire 4 incorporated into the fabric 2 is then heated by means of electric current to a temperature T which lies above the temperature Aₛ.

By appropriate choice of the materials or the composition of the alloy for the memory wire 4, the temperature Aₛ can be set so that it lies above the maximum body temperature or ambient temperature. A result of this is, for example, that the electric current source can be removed after heating of the memory wire 4 and, consequently, the contraction of the fabric 2, while the supporting function and the contraction of the fabric 2 are still retained. The temperature M_{f}, at which the linear extension begins again during cooling of the memory wire 4, is in this case chosen in such a way that it is lower than the body temperature or ambient temperature. Thus, the support or compression dressing can be removed again in a simple way by means of the dressing present on the body being cooled, for example by means of ice bags.

Instead of a single memory wire 4, as represented in FIG. 2 for example, it is also possible for several memory wires 4 to be incorporated into the fabric 2. Several memory wires 4 can then be electrically connected in parallel or in series. A separate electrical control is also possible.

The characteristic temperatures M_{f}, Mₛ, A_{f} and Aₛ can be adjusted within certain limits by appropriate choice of material and its composition. Alloys possessing shape memory properties are NiTi, Cu-Zn-Al and Cu-Al-Ni alloys. Further information on suitable materials or alloys is known, for example, from the periodical METALL, 41st year, volume 5, May 1987, pages 488 to 493.

FIGS. 4a and 4b are diagrammatic representations which show preferred means of securing the memory wire or memory wires 4 in or on the fabric 2. In the embodiment shown in FIG. 4a, the memory wire or memory wires 4 is/are stitched onto the fabric 2 by means of stitches 5. In the embodiment shown in FIG. 4b, the fabric 2 comprises two layers 2a and 2b, and the memory wire or memory wires 4 is/are welded in or else sewn in between these two layers 2a and 2b. In both cases, the composite fabric according to the invention is manufactured in a simple way, since no specially manufactured fabric is required, and instead the memory wires 4 are incorporated on or between conventional and commercially available fabrics.

FIG. 5 is a diagrammatic representation of a massage device or a device 10 for intermittent compression in the treatment of edemas, which device is arranged by way of example on a person's arm 12. The massage device 10 comprises a sleeve 14 into which the arm 12 is introduced. Memory wires 4-1, 4-2, 4-3 and 4-4 are incorporated into the sleeve 14 and they contract when the temperature is increased to above the temperature As and thus exert a pressure action through the sleeve 14 approximately perpendicular to the skin surface of the arm 12. The sleeve 14 is subdivided into four contiguous, tubular areas 14-1, 14-2, 14-3 and 14-4. The areas 14-i are in each case traversed by the memory wires 6-i. The memory wires 6-i are linked via electrical connections 8-i and 9-i to a pressure control device 16.

By means of the pressure control device 16, the individual memory wires 6-i in the individual areas 14-i of the sleeve 14 can be heated selectively and independently of one another by current impulses. In this way it is possible to build up a pressure wave which propagates, for example, from the area 14-1 to the area 14-4. In addition to this, it is possible with the massage device 10 according to the invention to build up a pressure gradient which has the effect, for example, that the pressure exerted on the arm 12 is at its highest in the area 14-1 and decreases toward the area 14-4.

If the memory wires 6 are incorporated in a suitable manner into a suit, then a pressure suit which can be operated electrically, and which replaces the complicated compressed-air pressure garments used by pilots and astronauts, is obtained in a simple way.

1. A flat composite fabric comprising a flat fabric (2) and filaments or wires (4) which are permanently incorporated therein and which are made of an alloy possessing shape memory properties.

2. The composite fabric as claimed in claim 1, wherein the wires (4) made of an alloy possessing shape memory properties are stitched onto the flat fabric (2).

3. The composite fabric as claimed in claim 1, wherein the flat fabric (2) comprises at least two layers (2a, 2b), and wherein the wires (4) made of an alloy possessing shape memory properties are sandwiched between the at least two layers of the fabric.

4. The composite fabric as claimed in claim 1, wherein the wires (4) made of an alloy possessing shape memory properties shorten when heated above a defined temperature Aₛ and once again assume their original shape when cooled below a defined temperature Mₛ (two-way memory effect).

5. The composite fabric as claimed in claim 1, wherein the fabric (2) is elastic.

6. The composite fabric as claimed in claim 1, wherein the wires (4) made of an alloy possessing shape memory properties have a round cross section.

7. The composite fabric as claimed in claim 1, wherein the wires (4) made of an alloy possessing shape memory properties are bent in the form of a flat spring.

8. The composite fabric as claimed in claim 7 wherein the wires (4) made of an alloy possessing shape memory properties are in a meandering configuration, the relationship of the radius R at the bend points to the radius of the wire being:
r/R×100%<8%

9. The composite fabric as claimed in claim 1, wherein the wires (4) made of an alloy possessing shape memory properties have different cross sections.

10. The composite fabric as claimed in claim 1, wherein the wires (4) made of an alloy possessing shape memory properties have connections (8, 9) for a current source.

11. The composite fabric as claimed in claim 1, wherein the wires (4) made of an alloy possessing shape memory properties comprise closed wire coils.

12. The composite fabric as claimed in claim 1, wherein the fabric (2) consists of an electrically insulating material.

13. The composite fabric as claimed in claim 1, wherein the fabric (2) is designed as a continuous dressing or bandage.

14. The composite fabric as claimed in claim 1, wherein the fabric (2) is designed as a sleeve (14).

15. The composite fabric as claimed in claim 1, wherein the wires (4) made of an alloy possessing shape memory properties consist of a Cu-Al-X alloy, where X is chosen from the elements Zn, Mn and Ni.

16. A compression or support dressing with a composite fabric as claimed in claim 4 wherein the temperature Aₛ is higher than the average temperature of the part of the body onto which the compression or support dressing is applied.

17. The compression or support dressing as claimed in claim 16, wherein the temperature Mₛ is lower than the average temperature of the part of the body onto which the compression or support dressing is applied.

18. The compression or support dressing as claimed in claim 16, wherein the wires (4) made of an alloy possessing shape memory properties comprise connectors to be connected to an electrical power supply.

19. A massage device with a cuff or sleeve (14) enclosing the part of the body to be massaged, and a pressure control device (16) for generating different pressures in different areas (14-i) of the sleeve (14), wherein
the sleeve (14) comprises composite fabric as claimed in claim 4,
the temperature Aₛ and the temperature Mₛ of the alloy possessing shape memory properties is higher than the average temperature of the part of the body to be massaged, and
the pressure control device (16) comprises an electrical control device for generating current impulses in the wires (4) made of an alloy possessing shape memory properties.

20. The massage device as claimed in claim 19 wherein different areas (14-i) of the cuff or sleeve (14) can be controlled separately by the pressure control device (16).

21. The massage device as claimed in claim 19, having at least one pressure sensor in the cuff or sleeve (14) for detecting the massage pressure.

22. A pressure suit for pilots and astronauts which consists of a fabric and of a pressure control device for generating different pressures in different areas of the pressure suit, wherein the fabric comprises a composite fabric as claimed in claim 1.

23. The pressure suit as claimed in claim 22, wherein the pressure control device comprises an electrical control device for generating current pulses in the wires made of an alloy possessing shape memory properties.
